(19) United States
(12) Patent Application Publication
(10) Pub. No.: US 2024/0367486 A1
(43) Pub. Date: Nov. 7, 2024

(54) VEHICLE CABIN HEATING SYSTEM USING WASTE HEAT SUPPLEMENTED HEAT PUMP WITH SUPPLEMENTAL HEATER

(71) Applicant: PACCAR Inc, Bellevue, WA (US)

(72) Inventors: Mazen Nachawati, Flower Mound, TX (US); Huateng Yang, Canton, MI (US)

(73) Assignee: PACCAR Inc, Bellevue, WA (US)

(21) Appl. No.: 18/311,028

(22) Filed: May 2, 2023

(51) Int. Cl. B60H 1/22; B60H 1/14

(52) U.S. Cl. CPC B60H 1/2218; B60H 1/143; B60H 2001/2237; B60H 2001/2246

(57) ABSTRACT

A vehicle cabin heating system of a vehicle, and methods of operation of such a heating system are provided. The vehicle cabin heating system scavenges waste heat from drivetrain components. A heat pump provides further heat scavenging for delivery to the vehicle cabin. A supplemental heater may be selectively activated to provide supplemental heating when operation of the heat pump and/or vehicle cabin heating system are inadequate to provide prompt heating response. The supplemental heater may, for example, be a positive temperature coefficient (PTC) heater positioned downstream of a heat pump heater and/or a heater core, and/or may include a positive high voltage coolant heater positioned within a coolant fluid circuit useable to heat coolant for delivery to the heater core and/or heat pump.

### BACKGROUND

Vehicle cabin heating systems typically use heat generated from an internal combustion engine, sometimes supplemented with other heating devices, to provide heat to a vehicle cabin. For example, a coolant system may draw heat away from an internal combustion engine and circulate that coolant to a vehicle cabin heater core, which uses the heated coolant to heat air that is circulated within the vehicle cabin.

In the case of battery-electric vehicles (BEVs), heat may be drawn away from electrical components of the vehicle (e.g., the vehicle battery pack, electronic axles, and the like) and conveyed via fluid lines in a generally analogous manner (e.g., via coolant or the like), to a vehicle cabin heater core. However, in some instances, particularly when vehicle operation commences after an extended period of time sitting in cold weather (sometimes referred to as a “cold soak”), drivetrain components have all reached a lower environmental temperature, so there is no significant waste heat from drivetrain components that can be scavenged for vehicle cabin heating. This can lead to prolonged cabin heating times, as significantly less energy in BEVs is converted to heat as compared to combustion engine vehicles.

To address the issue of inadequate vehicle cabin heating, BEVs have incorporated additional heating systems. However, these additional heating systems or heating components often require significant energy consumption to operate. This is particularly the case in large BEVs such as battery-electric tractor trailers, which require sizable electronic and drivetrain components and may also have a requirement of generating significant heat to adequately defrost and/or heat an entirety of a vehicle cabin and/or sleeper cabin.

### SUMMARY

Generally speaking, the present disclosure is directed to a vehicle cabin heating system of a vehicle, and methods of operation of such a heating system. The vehicle cabin heating system is useable, for example, in a battery electric vehicle. The vehicle cabin heating system scavenges waste heat from drivetrain components. A heat pump provides further heat scavenging for delivery to the vehicle cabin. A supplemental heater may be selectively activated to provide supplemental heating when operation of the heat pump and/or vehicle cabin heating system are inadequate to provide prompt heating response. The supplemental heater may, for example, be a positive temperature coefficient (PTC) heater positioned downstream of a heat pump heater and/or a heater core. The supplemental heater may. alternatively, include a positive high voltage coolant heater positioned within a coolant fluid circuit useable to heat coolant for delivery to the heater core and/or heat pump.

In a first aspect, a vehicle includes a drivetrain, a vehicle cabin heater core, and a coolant system being configured to flow coolant to absorb heat from the drivetrain and flow coolant to the vehicle cabin heater core. The vehicle also includes a refrigerant circulation system, a temperature sensor, and a heat exchanger fluidically connected to the coolant system and the refrigerant circulation system to transfer heat from the coolant to refrigerant within the refrigerant circulation system. The vehicle includes a heat pump heater fluidically connected to the heat exchanger via the refrigerant circulation system, as well as a supplemental heater. The vehicle includes an electronic control unit electrically connected to the temperature sensor. The electronic control unit is configured to perform: monitoring a temperature at the temperature sensor: based on the temperature being below a threshold temperature, activating the supplemental heater: and based on the temperature exceeding the threshold temperature, deactivating the supplemental heater and providing vehicle cabin heat via one or both of the vehicle cabin heater core and the heat pump heater.

In a second aspect, a method of operating a vehicle cabin heating system of battery electric vehicle is disclosed. The method includes monitoring, by an electronic control unit of the battery electric vehicle, a temperature at a temperature sensor, the temperature sensor being positioned within a vehicle cabin heating system. The method also includes, based on the temperature being below a threshold temperature, activating. a supplemental heater. The method includes, based on the temperature exceeding the threshold temperature, deactivating the supplemental heater and providing vehicle cabin heat via one or both of a vehicle cabin heater core and a heat pump heater.

In a third aspect, a vehicle cabin heating system is provided. The vehicle cabin heating system includes a vehicle cabin heater core fluidically connected to a coolant system of a vehicle, and a refrigerant circulation system. The vehicle cabin heating system includes a heat exchanger fluidically connected to the coolant system and the refrigerant circulation system to transfer heat from the coolant to refrigerant within the refrigerant circulation system, a heat pump heater fluidically connected to the heat exchanger via the refrigerant circulation system, and a supplemental heater. The vehicle cabin heating system includes an electronic control unit configured to perform: monitoring a temperature of at least one of the coolant or air output from the heat pump heater: based on the temperature being below a threshold, activating the supplemental heater: and, based on the temperature exceeding the threshold, deactivating the supplemental heater and providing vehicle cabin heat via one or both of the vehicle cabin heater core and the heat pump heater.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 is a schematic illustration depicting a side view of a vehicle including a vehicle cabin heating system.

FIG. 2 is a schematic diagram of a vehicle cabin heating system implementing aspects of the present disclosure, as integrated into a battery-electric vehicle.

FIG. 3 is a flowchart of a method of operating a vehicle cabin heating system, in accordance with an example embodiment.

FIG. 4 is a schematic diagram of a vehicle cabin heating system using an air heater downstream of a heat pump heater, in accordance with an example embodiment.

FIG. 5 is a flowchart of an example method of operating the vehicle cabin heating system of FIG. 4.

FIG. 6 is a chart illustrating heating response of various operational modes of a vehicle cabin heating system in accordance with the embodiment of FIGS. 4-5.

FIG. 7 is a schematic diagram of a vehicle cabin heating system using a coolant heater within a portion of a coolant system of a battery electric vehicle, in accordance with an example embodiment.

FIG. 8 is a flowchart of an example method of operating the vehicle cabin heating system of FIG. 7.

FIG. 9 is a block diagram of an example physical components of a computing device or system with which embodiments may be practiced.

### DETAILED DESCRIPTION

As briefly described above, embodiments of the present invention are directed to a vehicle cabin heating system of a vehicle, and methods of operation of such a heating system. The vehicle cabin heating system is useable, for example, in a battery electric vehicle. The vehicle cabin heating system scavenges waste heat from drivetrain components. A heat pump provides further heat scavenging for delivery to the vehicle cabin. A supplemental heater may be selectively activated to provide supplemental heating when operation of the heat pump and/or vehicle cabin heating system are inadequate to provide prompt heating response. The supplemental heater may, for example, be a positive temperature coefficient (PTC) heater positioned downstream of a heat pump heater and/or a heater core. The supplemental heater may, alternatively, include a positive high voltage coolant heater positioned within a coolant fluid circuit useable to heat coolant for delivery to the heater core and/or heat pump.

In example implementations, a temperature of a portion of the vehicle cabin heating system or coolant system may be monitored. Based on the temperature, a controller, such as an electronic control unit (ECU) of a vehicle, may control one or more valves and/or one or more supplemental heaters, to enable use of a supplemental heater in cold conditions where a vehicle cabin heater core and/or a heat pump do not provide adequate heating. The temperature may be determined, for example, in an airflow path of air to be delivered to the vehicle cabin. The temperature may alternatively (or in addition) be determined in a coolant path output from vehicle drivetrain components to determine whether sufficient waste heat may be scavenged by the vehicle cabin heater core and/or a heat pump heater. In response to the temperature exceeding a predetermined threshold, operation of the supplemental heater may cease, as sufficient waste heat may be available to accomplish heating using the heat pump heater and vehicle cabin heater core, or the vehicle cabin heater core alone.

The vehicle cabin heating system described herein, as well as the vehicle in which such a system is integrated and its method of operation, provide significant advantages in a variety of vehicle contexts, in particular in association with battery-electric vehicles (BEVs). In particular, selective use of a supplemental heater may improve heating response of a vehicle cabin, while deactivation once adequate waste heat is available to a heater core and/or heat pump reduces overall energy consumption of the vehicle cabin heating system, thereby improving vehicle range. Furthermore, by conditioning activation of such a supplemental heater on particular temperatures relevant to the availability of waste heat for cabin heating, appropriate heating systems may be selected for use in different operating conditions, for example after a cold soak of operating components, including a vehicle coolant system and/or vehicle drivetrain components, during or immediately after recent operation, or other conditions. Additionally, such controlled activation of supplemental heaters avoids a requirement that a vehicle operator individually activate and/or deactivate supplemental heaters, which may result in inefficient usage of such heaters during a time when adequate waste heat may be scavenged for use in vehicle cabin heating, leading to unnecessary energy consumption and resultant decreased vehicle range.

The detailed description set forth below in connection with the appended drawings is an illustrative and non-limiting description of various embodiments of the disclosed subject matter. Wherever possible, the same reference numbers are used in the drawings and the following description to refer to the same or similar elements. In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

The following description proceeds with reference to examples of systems and methods suitable for use in vehicles, such as Class 8 trucks. Although illustrative embodiments of the present disclosure will be described hereinafter with reference to vehicles, it will be appreciated that aspects of the present disclosure have wide application, and therefore, may be suitable for use with many types of vehicles, such as trucks, passenger vehicles, buses, commercial vehicles, light and medium duty vehicles, etc.

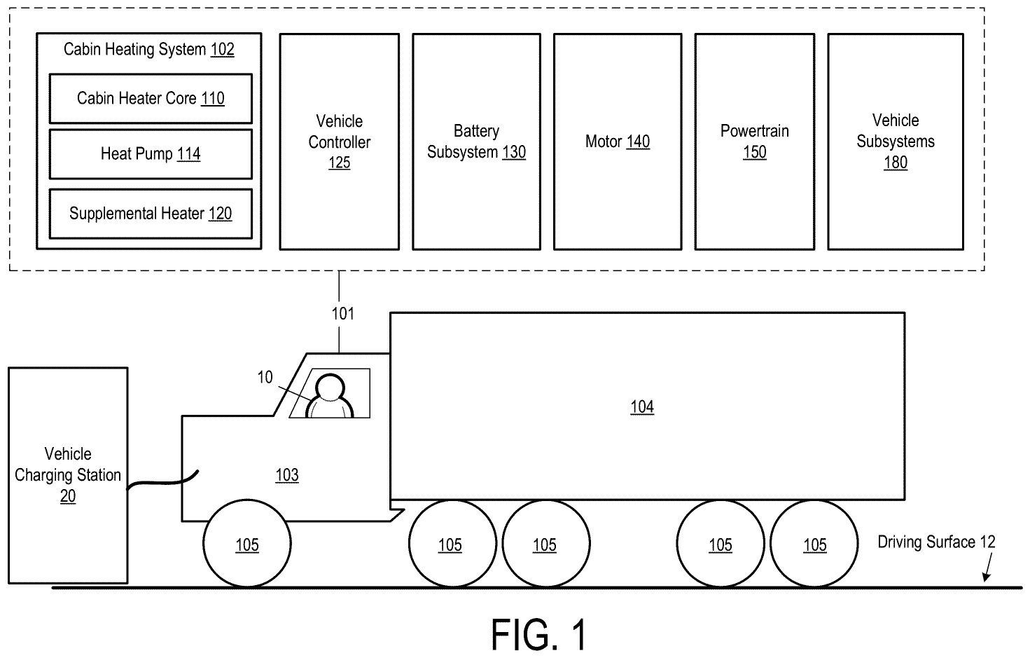

With reference now to FIG. 1, an example vehicle 101 is illustrated within which aspects of the present disclosure can be implemented. For example, FIG. 1 includes a side view of the vehicle 101 further including a schematic view of various components that may be included in the vehicle 101 that may operate as part of example implementations of vehicle cabin heating. In some examples, the vehicle 101 may be a heavy-duty truck such as a part of a tractor-trailer combination. The vehicle 101 may have what is sometimes referred to as, a fifth wheel by which a box-like, flat-bed, or tanker semi-trailer 103 (among other examples) may be attached for transporting cargo or the like. While the vehicle 101 is depicted as a truck in FIG. 1, it should be appreciated that the present technology is applicable to any type of vehicle where vehicle cabin heating may be desired, in particular in the context of a battery-electric vehicle (BEV).

In the example shown, the vehicle 101 has a tractor portion 103 and a trailer portion 104, and is propelled on a plurality of wheels 105 on a driving surface 12. The vehicle 101 may be operated by a vehicle operator 10, who operates the vehicle from a vehicle cabin area. The vehicle cabin area is positioned within the tractor portion 103, and may include a primary vehicle cabin and/or a sleeper area. In some examples, the vehicle 101 may include a vehicle cabin heating system 102, as well as a vehicle controller 125, as well as a battery subsystem 130, a motor 140, a powertrain 150, and various other vehicle subsystems 180.

The vehicle cabin heating system 102 may include a vehicle cabin heater core 110, as well as a heat pump heater 114 and a supplemental heater 120. The vehicle cabin heater core 110 may be positioned under a dashboard or inside an engine compartment of the vehicle, and is operably connected to other systems of the vehicle, such as the vehicle controller 125, as well as a coolant system useable for cooling the battery subsystem 130, motor 140, and powertrain 150. The heat pump heater 114 provides an additional heat delivery mechanism for delivering heated air to a vehicle cabin of the tractor 103, and may be connected (as detailed below) to a heat exchanger which also draws heat from the coolant system of the vehicle. As such, both the vehicle cabin heater core 110 and heat pump heater 114 provide heat to the vehicle cabin by scavenging heat generated by other vehicle subsystems. In the example shown, the vehicle cabin heating system 102 includes a supplemental heater 120. The supplemental heater 120 provides an independent source of heat for a vehicle cabin. In example embodiments discussed below; the supplemental heater 120 may directly heat air to be delivered to a vehicle cabin, or may heat coolant that is delivered to the vehicle cabin heater core 110 and heat pump heater 114 when insufficient heat is able to be scavenged from vehicle drivetrain components and/or other vehicle subsystems.

Generally, the vehicle cabin heating system 102 is configured to provide heating in accordance with acceptable standards for heating in cold conditions. For example, in some use cases after a “cold soak” of −20 degrees Celsius, it is desirable to be able to perform a defrosting operation such that 95% of a vehicle windshield is clear within 15 minutes, and side windows of the vehicle cabin are clear within 30 minutes. Other standards may be used for vehicle cabin heating responsiveness as well.

The vehicle controller 125 includes a programmable circuit, such as a computing device, which may be operable to control one or more subsystems of the vehicle 101. For example, the vehicle controller 125 may be implemented as a vehicle electronic control unit (ECU), and may receive one or more sensor signals associated with the vehicle cabin heating system 102, battery subsystem 130, motor 140, powertrain 150, or other vehicle subsystems 180, and may provide control signals, for example via a control bus within the vehicle, for actuating one or more subsystems in response to sensed conditions and/or user inputs. In some example embodiments, the vehicle controller 125 may include instructions for controlling the vehicle cabin heating system 102, as described in further detail below.

The battery subsystem 130 includes one or more batteries that are usable to power accessory subsystems within the vehicle 101, as well as batteries used to power the motor 140 and associated powertrain 150 (e.g., in the case of the electric or plug-in hybrid electric vehicle). In some example instances, the battery subsystem 130 may include a connector configured to receive a connection from an external electrical source, such as a vehicle charging station 20.

The motor 140 and associated powertrain 150 may operate to generate power and to convert the power into movement. For example, the motor 140 may include a power source, such as an engine, and the powertrain 150 various components that operate to convert the engine's power into movement of the vehicle (e.g. the transmission, driveshafts, differential, and axles). In some cases, the powertrain 150 may be one of various types of powertrains (e.g., diesel, hydrogen fuel cell, battery electric). In some examples, the powertrain 150 may be operable with the motor 140 to selectively operate as a generator, for example in the case of a regenerative braking arrangement.

In particular embodiments, the battery subsystem 130 includes a high voltage battery pack and the motor includes one or more electric motors. In some instances, a motor 140 and associated powertrain 150 may be packaged within an e-axle (packaging an electric motor, power electronics, and transmission into a single unit). In such instances, one or more electric motors may be used, either in a single e-axle or across a plurality of e-axles. Additionally, one or more high voltage battery packs may be included as well.

In an example where the powertrain 150 comprises a battery electric powertrain operable with an electric motor implementing the motor 140 and battery subsystem 130 (or, in the alternative, a plug-in hybrid drivetrain that uses, in part, electrical power from battery subsystem 130 for power to the motor 140 and in part uses an internal combustion engine to drive the powertrain 150), the vehicle 101 may be operatively connectable to a vehicle charging station 20. The vehicle charging station 20 may be a home or commercial vehicle charging station capable of supplying external electrical power to the vehicle, in particular for recharging battery subsystem 130.

The vehicle 101 may include one or more other vehicle subsystems 180, such as coolant systems for regulating temperature of operating systems of the vehicle, as well as accessory power systems, lighting systems, communication systems, and various other types of equipment. Each of the other vehicle subsystems 180 may also be powered via the battery subsystem 130.

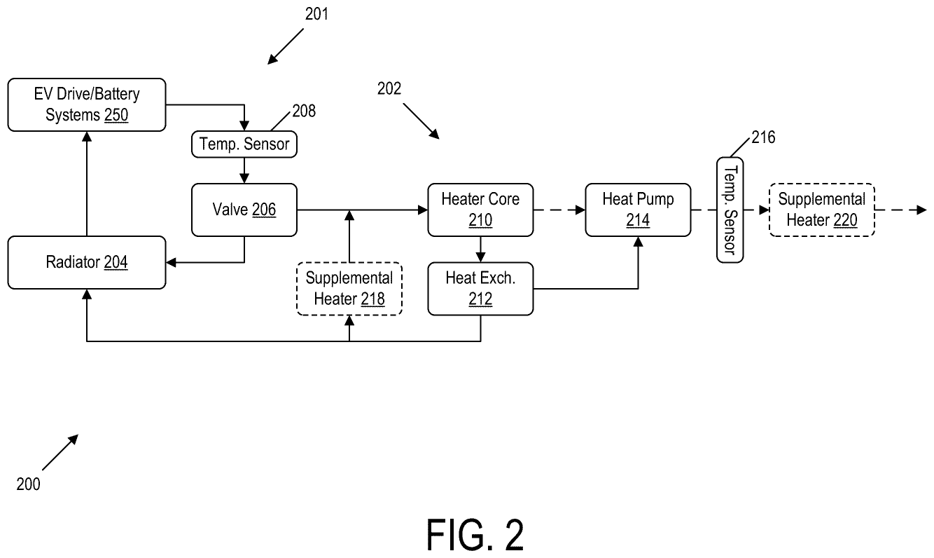

FIG. 2 is a schematic diagram of vehicle subsystems 200 that includes a vehicle cabin heating system implementing aspects of the present disclosure, as integrated into a battery-electric vehicle. In the example shown, the vehicle subsystem 200 illustrates a schematic version of a coolant system 201 and a vehicle cabin heating system 202.

In the example shown, the coolant system 201 includes a coolant circuit formed among a radiator 204, electric vehicle drive systems 250, and a valve 206. Generally speaking, the radiator 204 routes coolant to the electric vehicle drive systems 250, which can include an electric motor and drivetrain (e.g., separate or incorporated together into an e-axle, as discussed above), and/or one or more battery subsystems. The coolant is routed back to the radiator 204 via valve 206. The radiator 204 provides a heat exchange device for dissipating heat generated by the electric vehicle drive systems 250. In the example as illustrated, a temperature sensor 208 monitors a temperature of the coolant within the coolant system 201, for example at an inlet to valve 206. The temperature sensor 208 therefore reports, for example to vehicle controller 125, a coolant temperature of coolant available to be routed to the vehicle cabin heating system 202.

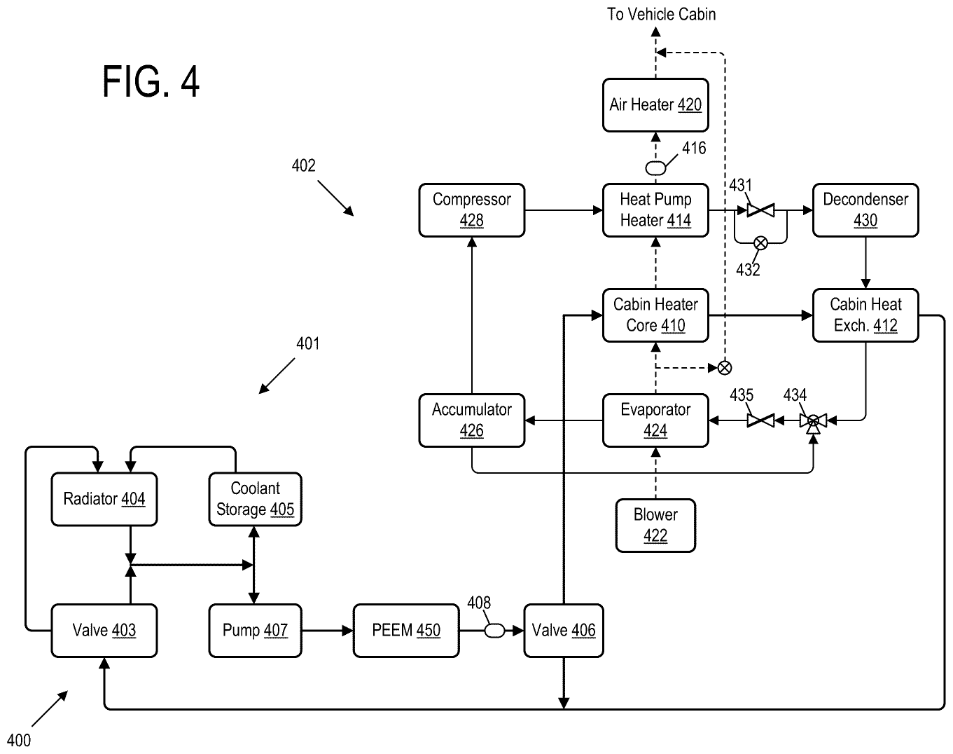

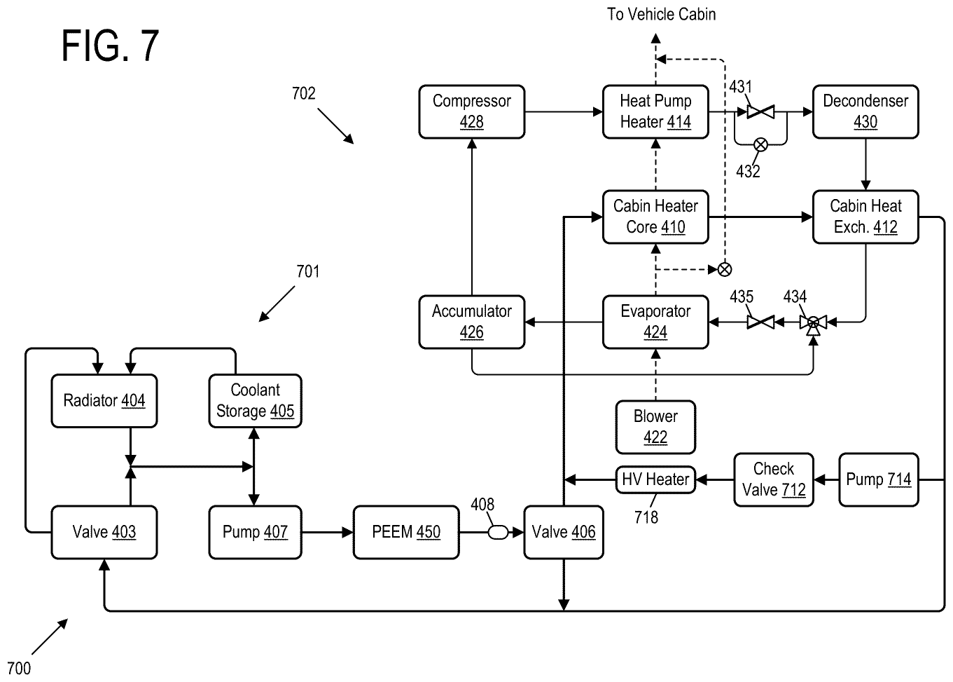

In the example shown, the vehicle cabin heating system 202 includes a vehicle cabin heater core 210, as well as a heat exchanger 212. The vehicle cabin heater core 210 and heat exchanger 212 are positioned to receive coolant from the coolant system 201, based on a position of valve 206. In particular, valve 206 may be movable between a first position in which coolant is flowed from the electric vehicle drive systems 250 through valve 206 to vehicle cabin heater core 210, and subsequently to heat exchanger 212. Coolant may then be returned to radiator 204 for further cooling prior to delivery back to the electric vehicle drive systems 250. The vehicle cabin heater core 210 may be heated by the coolant, and a blower (not shown, seen in particular embodiments in FIGS. 4 and 7) may blow air past the vehicle cabin heater core 210, thereby warming the air (airflow path shown as the dashed line in FIG. 2). Additionally, the heat exchanger 212 may use residual heat in the coolant to warm a refrigerant in the vehicle cabin heating system, which may be routed to a heat pump 214. The heat pump 214 may act to further heat air within the air flow path prior to delivery to the vehicle cabin.

As mentioned above, the use of the vehicle cabin heater core 210 and the heat pump 214 to provide heat to a vehicle cabin is limited by the extent to which coolant received at the vehicle cabin heating system 202 is heated, for example within the coolant system 201 by the electric vehicle drive systems 250. In circumstances where little heat is available to be scavenged from the coolant system 201, one or more supplemental heaters may assist with providing heat usable by the vehicle cabin heating system 202.

In one example, a supplemental heater 218 may be positioned to flow coolant returned by heat exchanger 212 back to the vehicle cabin heater core 210, further providing heating of that coolant. In this example, when a control system, such as vehicle controller 125, determines that a temperature of coolant within the coolant system 201 is below a threshold, the valves 206 may be controlled to circulate coolant from the electric vehicle drive system 250 back to the radiator 204, without delivering that coolant to the heater core 210. In this case, because coolant does not flow from valve 206 to heater core 210, the supplemental heater 218 may provide heat and coolant flow within the vehicle cabin heating system 202 regardless of a temperature of coolant within the coolant system 201. As such, the heater core 210 and heat exchanger 212 may receive heated coolant before adequate heat may be scavenged from the coolant system 201, e.g., from electric vehicle drive system 250.

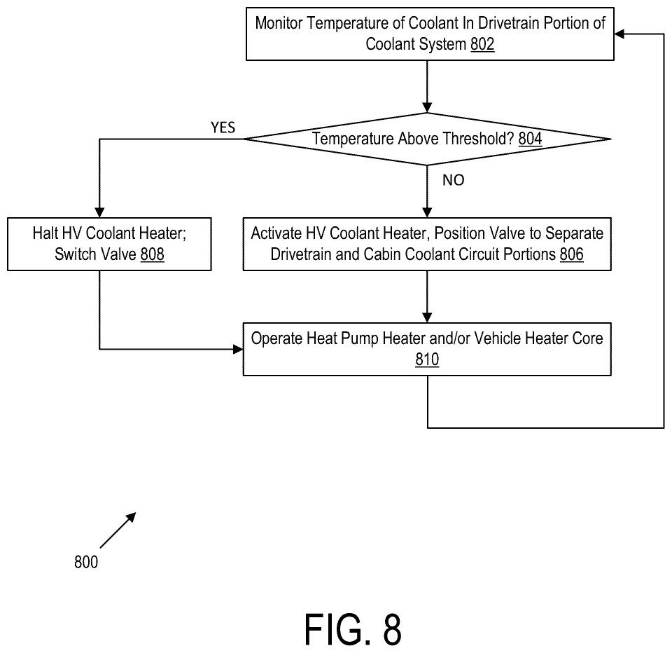

In example implementations, such as described below in conjunction with FIGS. 7-8, the supplemental heater 218 may be implemented as a high voltage coolant heater. Such a high voltage coolant heater may have an energy consumption rate that is greater than that of the heat pump 214. As such, when coolant within the coolant system 201 is above a threshold temperature, it may be desirable to not activate the supplemental heater 218 to avoid energy usage, relying instead on the heater core 210 and heat pump 214 to provide vehicle cabin heat. However, when the coolant within the coolant system 201 is below the threshold temperature, it may be desirable to use the supplemental heater 218 to provide faster coolant heating within the vehicle cabin heating system 202, and therefore faster heating of cabin airflow from the heater core 210 and heat pump 214.

In another example, a supplemental heater 220 may be positioned downstream toward a vehicle cabin from the heat pump 214. In this instance, the supplemental heater 220 may directly heat air, rather than heating coolant that is then used to heat the air as in the example of supplemental heater 218. In this configuration, a temperature sensor 216 may also be used to detect and output temperature of air flowing from heat pump 214 and vehicle cabin heater core 210 (in addition to, or instead of, temperature sensor 208). If the vehicle controller 125 determines, via temperature sensor 216 or temperature sensor 208, that an the heat pump is incapable of delivering adequate heating (e.g., based on air temperature at sensor 216 or coolant temperature at sensor 208 being below a respective threshold), the supplemental heater 220 may be activated. If the vehicle controller 125 determines that the output temperature of the heat pump 214 and/or vehicle cabin heater core 210 is above a threshold, the vehicle controller 125 may deactivate the supplemental heater 220, thereby reducing energy consumption.

Regarding supplemental heater 220, it is noted that in some instances, supplemental heater 220 may be operated in circumstances when heat pump 214 is not operated. For example, if it is determined, for example by the vehicle controller 125 based on signals sensed at temperature sensor 216 and/or temperature sensor 208 that inadequate waste heat is available to be scavenged by the heat exchanger 212 and heat pump 214, the supplemental heater 220 may be operated and heat pump 214 may not be in operation. However, temperatures upstream of the supplemental heater (e.g., away from the vehicle cabin) may yet change, for example due to heat generation within the electric vehicle drive systems 250 that is delivered to heater core 210.

In example implementations, such as described below in conjunction with FIGS. 4-6, the supplemental heater 220 may be implemented as a positive temperature coefficient (PTC) heater. Such a positive temperature coefficient heater may have an energy consumption rate that is greater than that of the heat pump 214. As such, similar to the high-voltage coolant heater described above, it is often desirable to not activate the supplemental heater 220 when heating via the heater core 210 and heat pump 214 is sufficient.

Although the vehicle subsystems 200 include a plurality of supplemental heaters 218, 220, it is noted that in some examples, only one such supplemental heater may be included. Furthermore, while temperature sensors 208, 216 are shown, more or fewer temperature sensors may be used, and may be located at other positions within the systems 200 overall. For example, both temperature sensors 208, 216 may be used despite the presence of only one of the supplemental heaters 218, 220, to provide additional feedback regarding heat delivery capabilities of the vehicle cabin heating system 202. Furthermore, although the present disclosure generally contemplates use of either coolant from the coolant system 201 or use of a supplemental heater 218, 220 for heating the vehicle cabin, in some instances, both may be used. Furthermore, supplemental heaters may be positioned in other locations while still operating consistently with the discussion herein. For example, supplemental heater 220 may be positioned upstream from the heat pump 214, or along a parallel airflow path to that running through the heat pump 214. Other configurations are possible as well.

Furthermore, it is noted that the vehicle subsystems 200 depicted in FIG. 2 are generally schematic in nature, and as such may include additional components and configurations not depicted. Examples of such further components and configurations are illustrated in conjunction with specific embodiments seen in FIG. 4 and FIG. 7, respectively, but it is recognized that the present disclosure is likewise not limited by those embodiments.

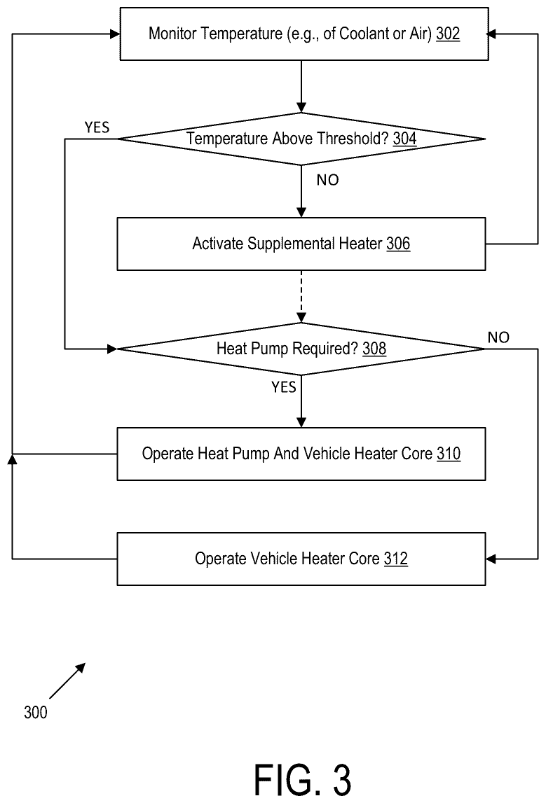

FIG. 3 is a flowchart of a method 300 of operating a vehicle cabin heating system, in accordance with an example embodiment. The method 300 represents a general method that may be performed by a vehicle controller 125 to control a vehicle cabin heating system, such as system 102, 202 described above.

In the example as illustrated, the method 300 includes monitoring a temperature that is indicative of heat able to be delivered to a vehicle cabin using a vehicle cabin heater core and/or a heat pump heater (step 302). Monitoring the temperature may include monitoring a temperature of coolant, for example downstream of electric vehicle drivetrain components. Monitoring the temperature may also or alternatively include monitoring a temperature of air output from comparatively lower energy consumption heating systems, such as the vehicle cabin heater core and/or heat pump heater.

In the example as illustrated, the method 300 further includes determining whether the monitored temperature is above a predetermined threshold (at operation 304). The predetermined threshold may be a threshold above which it is determined that the vehicle cabin heater core and/or heat pump heater may adequately deliver heat to the vehicle. The threshold may be able to be set via a vehicle controller, such as an ECU, and may be adjustable or preset. Additionally, the threshold may differ based on the location of a temperature sensor receiving a temperature reading. For example, a threshold temperature for coolant at temperature sensor such as sensor 208 of FIG. 2 may be selected to be at or above 50 degrees Celsius, or above about 120 degrees Fahrenheit. However, other thresholds may be used as well, and may be selected based on testing of vehicle cabin heating responsiveness of the vehicle cabin heater core and/or heat pump heater at that coolant temperature.

If, at operation 304, the sensed temperature is determined not to be above the predetermined threshold, a supplemental heater may be activated (step 306). Activating the supplemental heater may include activating a high voltage coolant heater, or a positive temperature coefficient (PTC) heater in various embodiments. Accordingly, heat may be generated by the vehicle cabin heating system even when inadequate coolant heating is provided by other vehicle systems, such that heat may be scavenged by the vehicle cabin heater core and/or heat pump heater.

If, at operation 304, the sensed temperature is above the predetermined threshold, a further determination is performed to see if operation of a heat pump is required (at operation 308). Determination of whether use of a heat pump is required may be based on a number of factors. These may include the current temperature of coolant within a coolant system, a current operating condition of electric motors and other drivetrain components of a BEV that would be indicative of heat generated by such components, a current heat or defrost setting selected by an operator within the vehicle cabin, or various other factors. In other words, generally speaking, if the threshold temperature is reached, but some additional heating is required, such heating may be provided using both the vehicle cabin heater core and a heat pump (step 310). However, if the threshold temperature is already reached, and little additional heating is required, such heating may be provided by only the vehicle cabin heater core, and use of both the heat pump heater and any supplemental heater may be unnecessary (step 312).

Regardless of which heater is selected for operation (e.g., the supplemental heater, heat pump, and or vehicle heater core), operational flow returns to step 302, to allow for continued monitoring of temperature such that once a coolant or air temperature reaches a threshold, operation of the supplemental heater may be discontinued to reduce energy consumption within the vehicle.

Additionally, it is noted that in some instances, even if a supplemental heater is activated, one or more of the heat pump and vehicle heater core may nevertheless continue in operation. This may be the case, for example, when the supplemental heater may be activated at graduated energy consumption levels, such that a mix of energy consumption by the supplemental heater, the heat pump, and vehicle heater core may provide an optimal mix of heating sources to arrive at fast, lowest energy consumption heat generation. However, in circumstances in which the supplemental heater operates in a binary manner (e.g., either on or off entirely), it may be preferential to activate a supplemental heater only when used in place of the heat pump and or vehicle cabin heater core.

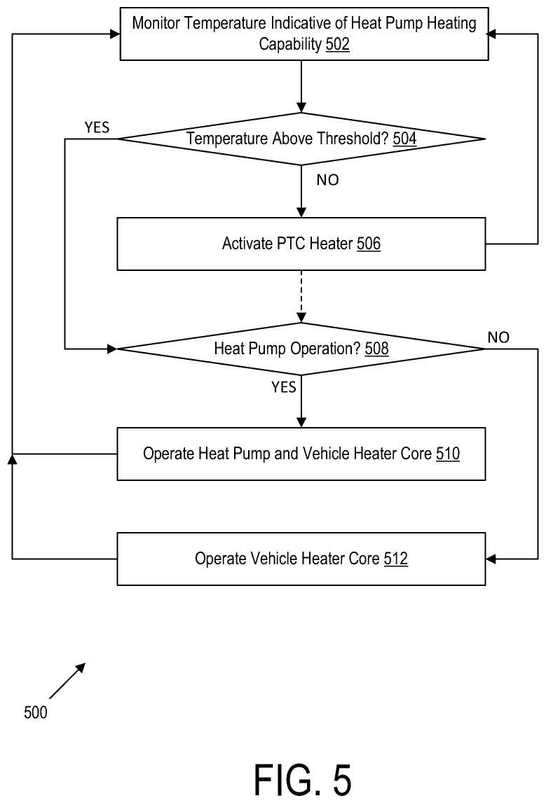

Referring now to FIGS. 4-5 a schematic diagram illustrating vehicle subsystems including a vehicle cabin heating system that utilizes an air heater downstream of a heat pump heater, and a method of operation, are provided. Referring first to FIG. 4, a schematic diagram of vehicle subsystems 400 including a coolant system 401 and vehicle cabin heating system 402 is illustrated. The vehicle subsystems 400 represent a specific, more detailed version of a particular embodiment of subsystems 200 of FIG. 2, described above, in a situation where a supplemental heater is positioned downstream within an airflow path from a heat pump heater and toward a vehicle cabin. That is, the vehicle subsystems 400 illustrate a particular example of use of a specific embodiment of a supplemental heater 220.

In this example, the coolant system 401 includes a valve 403, a radiator 404, a coolant storage tank 405, a pump 407, PEEM 450, and valve 406 which connects the coolant system 401 to the vehicle cabin heating system 402. Generally speaking, pump 407 circulates coolant within the coolant system 401. The pump 407 moves coolant toward and past power electronics and electric motor subsystem, referred to as PEEM 450. The PEEM 450 will generate waste heat during operation of the vehicle, and as such, coolant passing PEEM 450 will absorb temperature to lower and/or control the operating temperature of the PEEM 450. Coolant is routed, via valve 406, either back toward valve 403 and radiator 404, or toward the vehicle cabin heating system 402, as discussed further below.

The valve 403 routes coolant either to the radiator 404 for cooling, to coolant storage tank 405, or to pump 407 for recirculation past the PEEM 450 if below a predetermined temperature. The radiator 404 performs a heat exchange process to cool the coolant using water/airflow as is known in the art. It is noted that although a radiator 404 is disclosed in the present embodiment, other types of heat exchange systems useable to draw heat away from PEEM 450 are useable as well, in example embodiments.

In the example shown, the valve 406 may be operably moved between a first position and a second position. In the first position, the valve 406 may be operated in a state that it routes coolant from the PEEM 450 and toward the vehicle cabin heating system 402. and in particular toward a vehicle cabin heater core 410. This may be, for example, when a temperature of the coolant is determined to be above a predetermined threshold, such as above 50 degrees Celsius or some other preset or adjustable coolant temperature threshold. In such a case, it can be determined that there is adequate waste heat generated by the PEEM 450 that may be scavenged for use in vehicle cabin heating.

In the second position, the valve may be positioned to route coolant back within the coolant system 401, without first routing that coolant toward the vehicle cabin heating system 402. As such, coolant may be routed through a shorter overall circuit, and if routed directly via valve 403 to pump 407 and back to PEEM 450 without passing through radiator 404 or other cooling system, the coolant may be more quickly heated to an operational temperature useable by the vehicle cabin heater system. In example embodiments described herein, routing coolant through this shorter overall fluid circuit may be referred to as routing coolant through a first coolant circuit portion, while routing coolant toward the vehicle cabin heater core 410 may be referred to as routing coolant through a second coolant circuit portion.

In the example shown, the vehicle cabin heating system 402 includes a plurality of fluidic routing systems, routing coolant, refrigerant, and air using a plurality of components. Regarding the coolant circuit, if the valve 406 is in the first position described above (e.g., a temperature of coolant in the coolant system 401 is above a threshold temperature), coolant is routed through the second coolant circuit portion as noted above, i.e., toward vehicle cabin heater core 410, and passes toward the cabin heat exchanger 412 before returning, via a return path, to the valve 403 as part of the coolant system 401. The vehicle cabin heater core 410 uses the heated coolant to heat air in an airflow path (shown in dashed lines) generated by a blower 422 and ending at a vehicle cabin. The blower 422 may be a fan-based blowing system and may draw air from either within the vehicle cabin or from an environment around the vehicle to be warmed by the vehicle cabin heater core 410 and various other heating systems.

In the example shown, downstream of the vehicle cabin heater core 410 along the airflow path, a heat pump heater 414 provides further heating. The heat pump heater 414 is connected to the cabin heat exchanger 412 via a refrigerant circuit, which is formed by a loop of components including the heat pump heater 414 and cabin heat exchanger 412, as well as an evaporator 424, an accumulator 426, a compressor 428, a decondenser 430, and a plurality of valves 431, 434, 435. The refrigerant circuit is generally constructed to provide heating, ventilation, and air conditioning (HVAC) to the vehicle cabin by heating or cooling refrigerant passing through the evaporator 424 and/or heat pump heater 414, which are positioned along an airflow path downstream of the blower 422, to be delivered to the vehicle cabin.

In the example shown, the cabin heat exchanger 412 will scavenge heat from the coolant lines downstream of the vehicle cabin core heater 410. In circumstances where heating is desired, the evaporator 424 may be inactive, allowing heated refrigerant to pass to the accumulator 426. The evaporator 424, positioned upstream of the vehicle cabin heater core 410 along the airflow path and after blower 422, could also be activated, and used for dehumidifying air from the blower 422. The evaporator 424 may be activated in other circumstances, for example to provide cooling of the air if desired. In some instances, such as when cabin heating is not desired, the airflow path may bypass the vehicle cabin heater core 410, heat pump heater 414, and supplemental heater, shown as air heater 420, to provide cooled air directly to the vehicle cabin.

The accumulator 426 receives refrigerant from the evaporator 424, and acts as a temporary storage tank for liquid refrigerant, allowing such refrigerant to boil off to become vapor before reaching compressor 428. The accumulator 426 may also return evaporated refrigerant back upstream of the evaporator 424, based on operation of valves 434, 435. This might be performed in the case where the evaporator is used for dehumidifying air concurrently with cabin air heating.

The compressor 428 receives low-pressure refrigerant vapor from the evaporator 424 and accumulator 426, and compresses it into high-pressure gas for use in heating and/or cooling operations. The compressed refrigerant may be delivered to the heat pump heater 414, which may heat air along the airflow path in accordance with a desired operating mode of the system. Relevant to the present disclosure, the heat pump heater 414 may receive pressurized refrigerant vapor from the compressor that is heated based on heat scavenged from the coolant at the cabin heat exchanger 412, to further heating of air in the airflow path.

From the heat pump heater 414, refrigerant may flow to a decondenser 430, selectively through valve 431 or via a bypass valve 432, which returns the refrigerant to a liquid state and returns that liquid refrigerant to the heat exchanger 412.

As described previously, an air heater 420 is positioned downstream of the heat pump heater 414 along the airflow path, e.g., toward the vehicle cabin. The air heater, in this example, can be a positive temperature coefficient (PTC) heater, which includes a heating element powered by electricity (as compared to relying on heated coolant or refrigerant, and the like), and can be activated by a vehicle controller (e.g., vehicle controller 125, such as an ECU) separately from the heat pump heater 414 and/or vehicle cabin heater core 410. The air heater 420 is positioned downstream from the heat pump heater 414, and selectively activated to provide heating of air either when the heat pump heater 414 and cabin heater core 410 are incapable of generating adequate heat, or in conjunction with operation of those components.

In the example shown, one or more temperature sensors may be used to monitor a temperature that is indicative of the ability of the heat pump heater 414 and/or cabin heater core 410 to deliver heat to a vehicle cabin. For example, a temperature sensor 408 positioned downstream within a coolant circuit 401 from PEEM 450) can monitor a coolant temperature to determine if the coolant is at a temperature such that heat may be scavenged by the heat pump heater 414 and/or cabin heater core 410. In a further example, a temperature sensor 416 is positioned at an output along the airflow path from the heat pump heater 414 to determine the output heat of the heat pump heater 414 and cabin heater core 410. In either instance, the air heater 420 may be activated, for example, based on the temperature at the sensor 408, the sensor 416, or some combination thereof, being below a threshold temperature, such that the air heater 420 may warm the air prior to reaching the vehicle cabin.

In example implementations, the air heater 420 may have an energy usage rate that is higher than that of the heat pump heater 414 and vehicle cabin heater core 410. For example, a PTC heater may operate at up to 7 kilowatts, whereas a heat pump heater may operate at up to 5 kilowatts. As such, during times when the heat pump heater 414 provides adequate heating to a vehicle cabin, it is desirable to deactivate the air heater 420 to avoid unnecessary energy consumption.

FIG. 5 is a flowchart of an example method 500 of operating the vehicle cabin heating system of FIG. 4. The method 500 is usable, for example, in conjunction with the vehicle cabin heating system 402 of FIG. 4, within the context of vehicle subsystems 400 described therein.

In the example shown, the method 500 includes monitoring a temperature indicative of heating capability of the heat pump heater 414 (step 502). The temperature may be monitored, for example, by a temperature sensor 408, in conjunction with a vehicle controller such as an ECU. The temperature determined at temperature sensor 408 may be a temperature of coolant, which indicates an amount of heat generated by drivetrain components (e.g., PEEM 450) and available to be scavenged. Additionally, or in the alternative, the monitored temperature may be determined at a temperature sensor 416, again in conjunction with a vehicle controller, such as an ECU.

In the example, shown, the vehicle controller may determine whether the monitored temperature is above a predetermined threshold (at operation 504). The predetermined threshold may be set by the vehicle controller at a point where it is efficient to provide vehicle cabin heating via the vehicle cabin heater core and heat pump. In examples, the predetermined threshold may be set at approximately 70° C. In other examples, other thresholds (e.g., generally in a range of 50°° C. to 90° C.) may be used. In such examples, different threshold temperatures may be used depending on whether the temperature is determined based on coolant temperature at temperature sensor 408, or air temperature at temperature sensor 416.

If the monitored temperature is below the predetermined threshold, the air heater (e.g., PTC heater) may be activated, thereby providing a supplemental heat source to air being delivered to the vehicle cabin (step 506). In this instance, operation may continue at step 502 to continue monitoring the temperature at the outlet of the heat pump heater, to determine when that temperature reaches the predetermined threshold.

If the monitored temperature is above the predetermined threshold, the air heater may be deactivated, and a determination of whether to use the heat pump may be performed (e.g., at operation 508). Determination of whether a heat pump should be utilized in combination with the vehicle cabin heater core may be based on a variety of factors including the desired vehicle cabin temperature setting, the current available waste heat to be scavenged, the heating capacity of the vehicle cabin heater core and/or the heat pump heater, and the like. If the heat pump is to be used, both the heat pump and the vehicle cabin heater core may be activated, thereby providing heat to the vehicle cabin based on scavenged heat from the PEEM 450 via the coolant system (step 510). If the heat pump is not to be used, only the vehicle cabin heater core may be activated, and heat may be provided by only that component (step 512). Use of only the vehicle cabin heater core may save some additional electrical energy if the heat pump heater is not necessary. In either case, operation returns to step 502, to continue monitoring a temperature downstream of the heat pump heater, to allow for reassessment of a particular heating mode to be used (use of the air heater, use of the heat pump heater and vehicle cabinet heater core, or use of only the vehicle cabin heater core).

Referring to the method 500 generally, it can be seen that by monitoring a temperature indicative of heating capability of the heat pump heater, a most efficient heating strategy may be selected to provide vehicle cabin heating using system components that consume the least amount of energy but are adequate to the task.

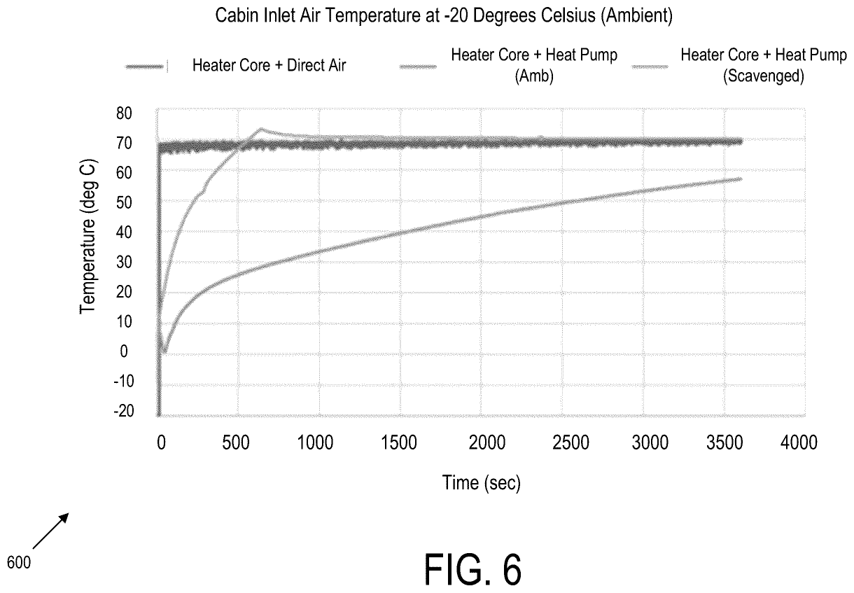

FIG. 6 is a chart 600 illustrating heating response of various operational modes of a vehicle cabin heating system in accordance with the embodiment of FIGS. 4-5. In particular, three different response modes of a vehicle cabin heating system are provided. A first mode uses both the vehicle cabin heater core and a direct air heater, such as air heater 420. As can be seen in the chart 600, the temperature of output air toward the vehicle cabin may be quickly brought up to a desired temperature (in the example shown, approximately 70° C.). In a second possible mode, the heater core and a heat pump are used, but the heat pump is used to scavenge heat from an ambient environment. In this example, heating of vehicle cabin air is prolonged, and in the example shown never reaches a target temperature (within the 3500 simulated seconds of operation). In a third possible mode, the heater core and a heat pump are used, but scavenge heat such as waste heat from BEV drivetrain components (e.g., PEEM 450 described above). In this example, the combination of the heater core and heat pump reach the target temperature within approximately 500 seconds, and are able to maintain that temperature on an ongoing basis.

Accordingly, it can be seen that through use of a combination of an air heater during a first period of time when little waste heat is available, and a heat pump and vehicle cabin heater core during a second period of time to scavenge waste heat from vehicle drivetrain components, a vehicle cabin heater may be operated efficiently and may provide quick heating response as needed. In the particular example shown, an air heater may be operated for only a first (approximately) 500 seconds, at which time it may be deactivated and the heat pump and vehicle cabin heater core may be used. Still further, as vehicle operation continues and a vehicle cabin is heated, it may be possible to cease operation of the heat pump heater as well, and rely solely on heating using the vehicle cabin heater core, thereby further reducing power consumption of the vehicle cabin heating system.

FIG. 7 is a schematic diagram of vehicle subsystems 700 including a coolant system 701 and a vehicle cabin heating system 702. The vehicle cabin heating system 702 uses a coolant heater within a portion of a coolant system of a battery electric vehicle, in accordance with an example embodiment.

Generally speaking, the vehicle subsystems 700 includes components analogous to those described above in conjunction with FIG. 4. However, rather than air heater 420, in this example embodiment a high-voltage (HV) coolant heater 718 may be positioned within the vehicle cabin heating system 702, in particular along a coolant path that re-circulates coolant output from the cabin heat exchanger 412 back to the vehicle cabin heater core 410. In this arrangement, the coolant path including the high-voltage coolant heater 718 may be selectively used to recirculate coolant within the vehicle cabin heating system 702 by opening a check valve 712 and operating pump 714. This will cause coolant to flow back toward the vehicle cabin heater core 410.

In examples, the high-voltage coolant heater 718 may be a heater that consumes more energy than the heat pump heater 414, and as such should be used in only limited circumstances where additional coolant heating is required. For example, the high-voltage coolant heater 718 may consume on the order of 12 kilowatts, as compared to 5 kilowatts in the case of heat pump heater 414. However, even if the high-voltage coolant heater 718 operated at a lower energy level, it may be advantageous to avoid its use concurrently with the heat pump heater 414, to avoid additive energy consumption of the two devices.

In operation, a coolant temperature may be determined within the coolant system 701, for example at a temperature sensor 408 which is positioned downstream of the PEEM 450, e.g., adjacent to the valve 406. If the coolant is below a predetermined threshold temperature (e.g., below about 50° C., or any threshold in a range of about 50-90° C.), it may be determined that the coolant from the coolant system 701 will not provide adequate waste heat to heat the vehicle cabin via the vehicle cabin heater core 410 and heat pump heater 414. As such, the vehicle controller (e.g., ECU) may actuate the valve 406 to a position such that coolant output from the PEEM 450 is returned through the coolant system 701, and not routed to the vehicle cabin heater core 410. Concurrently, the high-voltage coolant heater 718 may heat coolant that is within the vehicle cabin heating system 702, and the pump 714 may operate to circulate that heated coolant to the vehicle cabin heater core 410 and cabin heat exchanger 412. Because the high-voltage coolant heater 718 provides independent heating of the coolant, it is not necessary to wait for the coolant to be heated within the coolant system 701, e.g., by PEEM 450 or other components therein, to obtain adequate vehicle cabin heating via the vehicle cabin heater core 410 and heat pump heater 414. Furthermore, by actuating the valve 406 to separate the coolant flows within the coolant system 701 and vehicle cabin heating system 702, the high-voltage coolant heater 718 may only be required to heat a smaller volume of coolant, thereby reducing the energy consumption required to heat the coolant to an adequate temperature.

Once the vehicle controller determines, based on a temperature sensed at the temperature sensor 408, that coolant within the coolant system 701 has reached the threshold temperature, the high-voltage coolant heater 718 may halt operation, the check valve 712 may be closed, and the pump 714 may cease operation as well. Additionally, the valve 406 may be actuated to allow coolant to flow from the coolant system 701 (e.g., from the output of PEEM 450) toward the vehicle cabin heater core 410 and heat exchanger 412, thereby using waste heat from the coolant system for cabin heating. As with the example of FIGS. 4-6, above, depending on the heating settings/requirements and current operating conditions, either the vehicle cabin heater core 410 may be used alone, or in combination with further heat scavenging by the heat exchanger 412 and heat pump heater 414.

FIG. 8 is a flowchart of an example method 800 of operating the vehicle cabin heating system of FIG. 7. The method 800 may be executed by a vehicle controller such as an ECU, e.g., vehicle controller 125 of FIG. 1, within the context of vehicle subsystems 700 described therein.

In the example shown, the method 800 includes monitoring a temperature of coolant within the coolant system (step 802). The temperature may be monitored, for example, by a temperature sensor 408, in conjunction with a vehicle controller, such as an ECU. The vehicle controller may determine whether the monitored temperature is above a predetermined threshold (at operation 804). The predetermined threshold may be set by the vehicle controller at a point where it is efficient to provide vehicle cabin heating via the vehicle cabin heater core and heat pump. In examples, the predetermined threshold may be set at approximately 50° C. In other examples, other thresholds (e.g., generally in a range of 50°° C. to 90° C.) may be used.

If the monitored temperature is below the predetermined threshold, the high-voltage coolant heater 718 may be activated to heat coolant within the vehicle cabin heating system 702 (step 806). Additionally, a check valve (e.g., check valve 712) may be opened and pump (e.g., pump 714) operated to circulate coolant back to the vehicle cabin heater core 410 and heat exchanger 412, for use to heat cabin air by the vehicle cabin heater core and heat pump heater 414. Additionally, a valve fluidically connecting the vehicle cabin heating system to the coolant system (e.g., valve 406) may be positioned to cause coolant within the coolant system 701 to recirculate rather than flow toward the vehicle cabin heater core, allowing that coolant to absorb waste heat.

If the monitored temperature within the coolant system 701 is above the predetermined threshold, the high-voltage coolant heater 718 may be deactivated, and an associated pump may cease operation, and a check valve 712 closed (step 808). Furthermore, the heat pump heater and/or vehicle cabin heater core may be operated to provide heat to the vehicle cabin, as noted above (at step 810). Still further, at step 810, the valve fluidically connecting the vehicle cabin heating system to the coolant system (e.g., valve 406) may be positioned to cause coolant within the coolant system 701 to flow toward the vehicle cabin heater core 410 and heat exchanger 412. Accordingly, heat provided to the vehicle cabin may be provided based on waste heat from, e.g., PEEM 450.

Operation of method 800 continues, from step 810, to return to step 802, to continue monitoring the temperature of coolant, e.g., to determine whether changes in operating modes of the vehicle subsystems 700 are desirable to achieve vehicle cabin heating with efficient energy usage.

Referring generally to the method 800, although the method is described as using both the heat pump heater and vehicle cabin heater core 410 throughout operation, it is recognized that, in some operating conditions, only the vehicle cabin heater core may be needed to operate. For example, after coolant from the coolant system 701 has reached the threshold temperature and the vehicle cabin has reached an adequate operating temperature, not only may it be possible to deactivate the high-voltage coolant heater 718 and route coolant from PEEM 450 through valve 406 toward the vehicle cabin heater core 410, but it may also be possible to deactivate the heat pump heater 414, relying solely on the vehicle cabin heater core 410 for heating. Such a decision may be made similarly to the manner described in conjunction with steps 508-512 of FIG. 5, in place of step 810.

Furthermore, and comparing the embodiments of FIGS. 4-6 and 7-8 generally, it is noted that in a general case, the air heater 420 of FIG. 4 is contemplated to operate either instead of, or in addition to, the vehicle cabin heater core 410 and/or heat pump heater 414. The high-voltage coolant heater 718, however, operates to heat coolant and therefore is used in conjunction with operation of one or both of the vehicle cabin heater core 410 and/or heat pump heater 414 (typically, both). In both embodiments, a supplemental heater having generally higher energy consumption may be used during a limited period of time, and its use may be discontinued once sufficient waste heat may be scavenged for use in vehicle cabin heating.

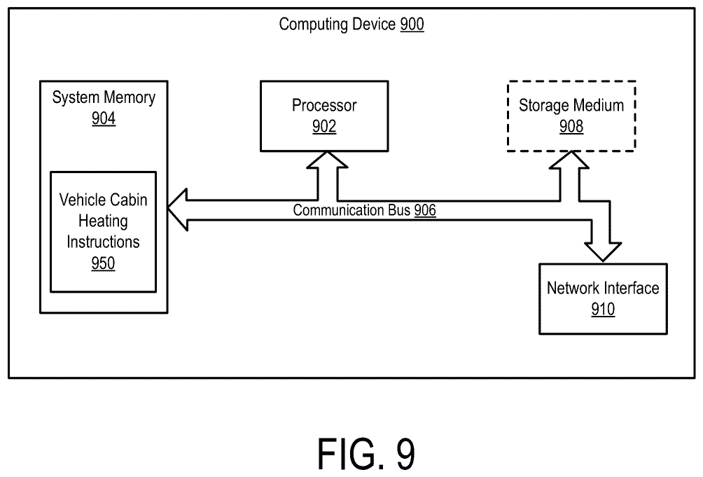

FIG. 9 is a block diagram of an illustrative computing device 900 appropriate for use in accordance with embodiments of the present disclosure. The description below is applicable to the vehicle controller 125, servers, personal computers, mobile phones, smart phones, tablet computers, embedded computing devices, and other currently available or vet-to-be-developed devices that may be used in accordance with embodiments of the present disclosure.

In its most basic configuration, the computing device 900 includes at least one processor 902 and a system memory 904 connected by a communication bus 906. Depending on the exact configuration and type of device, the system memory 904 may be volatile or nonvolatile memory, such as read-only memory (“ROM”), random access memory (“RAM”), EEPROM, flash memory, or other memory technology. Those of ordinary skill in the art and others will recognize that system memory 904 typically stores data or program modules that are immediately accessible to or currently being operated on by the processor 902. In this regard, the processor 902 may serve as a computational center of the computing device 900 by supporting the execution of instructions. According to one example, the system memory 904 may store one or more components of the vehicle cabin heating system, such as vehicle cabin heating system instructions 950.

As further illustrated in FIG. 9, the computing device 900 may include a network interface 910 comprising one or more components for communicating with other devices over a network. Embodiments of the present disclosure may access basic services that utilize the network interface 910 to perform communications using common network protocols. The network interface 910 may also include a wireless network interface configured to communicate via one or more wireless communication protocols, such as WiFi, 2G, 3G, 4G, 5G, LTE, WiMAX, Bluetooth, or the like.

In the illustrative embodiment depicted in FIG. 9, the computing device 900 also includes a storage medium 908. However, services may be accessed using a computing device that does not include means for persisting data to a local storage medium. Therefore, the storage medium 908 depicted in FIG. 9 is optional. In any event, the storage medium 908 may be volatile or nonvolatile, removable or non-removable, implemented using any technology capable of storing information such as, but not limited to, a hard drive, solid state drive, CD-ROM, DVD, or other magnetic and/or optical disk storage.

As used herein, the term “computer-readable medium” includes volatile and nonvolatile and removable and non-removable media implemented in any method or technology capable of storing information, such as computer-readable instructions, data structures, program modules, or other data. In this regard, the system memory 904 and storage medium 908 depicted in FIG. 9 are examples of computer-readable media.

For ease of illustration and because it is not important for an understanding of the claimed subject matter, FIG. 9 does not show some of the typical components of many computing devices. In this regard, the computing device 900 may include input devices, such as a keyboard, keypad, mouse, trackball, microphone, video camera, touchpad, touchscreen, electronic pen, stylus, or the like. Such input devices may be coupled to the computing device 900 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 900 (e.g., a client device), or can be integral components of the computing device 900. In some embodiments, multiple input devices may be combined into a single, multifunction input device (e.g., a video camera with an integrated microphone). The computing device 900 may also include output devices such as a display, speakers, printer, etc. The output devices may include video output devices such as a display or touchscreen. The output devices also may include audio output devices such as external speakers or earphones. The output devices can be separate from and communicatively coupled to the computing device 900, or can be integral components of the computing device 900. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, PythonScript, VBScript, ASPX, Microsoft.NET™ languages such as C#, or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. A vehicle comprising:
a drivetrain;
a vehicle cabin heater core;
a coolant system being configured to flow coolant to absorb heat from the drivetrain and flow coolant to the vehicle cabin heater core;
a refrigerant circulation system;
a temperature sensor;
a heat exchanger fluidically connected to the coolant system and the refrigerant circulation system to transfer heat from the coolant to refrigerant within the refrigerant circulation system;
a heat pump heater fluidically connected to the heat exchanger via the refrigerant circulation system;
a supplemental heater; and
an electronic control unit electrically connected to the temperature sensor, the electronic control unit being configured to perform:
monitoring a temperature at the temperature sensor;
based on the temperature being below a threshold temperature, activating the supplemental heater; and
based on the temperature exceeding the threshold temperature, deactivating the supplemental heater and providing vehicle cabin heat via one or both of the vehicle cabin heater core and the heat pump heater.

2. The vehicle of claim 1, further comprising a valve positioned within the coolant system between a first coolant circuit portion including the drivetrain and a second coolant circuit portion including the vehicle cabin heater core.

3. The vehicle of claim 2, wherein:
the valve is movable between a first position and a second position,
in the first position the valve fluidically connects the first coolant circuit portion to the second coolant circuit portion to flow coolant from the drivetrain to the vehicle cabin heater core and heat exchanger, and
in the second position the valve recirculates coolant within the first coolant circuit portion without flowing coolant toward the vehicle cabin heater core and heat exchanger.

4. The vehicle of claim 3, wherein the supplemental heater comprises a high voltage (HV) coolant heater positioned in the coolant system.

5. The vehicle of claim 4, wherein the high voltage coolant heater is positioned in the second coolant circuit portion, and wherein the controller is configured to:
activate the high voltage coolant heater in response to determining, at the temperature sensor, a coolant temperature below a threshold; and
maintain the valve in the second position until the controller determines that a coolant temperature at the temperature sensor is above a threshold temperature.

6. The vehicle of claim 5, wherein the temperature sensor is positioned within the first coolant circuit portion.

7. The vehicle of claim 3, wherein the supplemental heater comprises a positive temperature coefficient heater.

8. The vehicle of claim 7, wherein the positive temperature coefficient heater is operable in response to a determination at the temperature sensor that a coolant temperature is below the threshold temperature.

9. The vehicle of claim 8, wherein the temperature sensor is positioned downstream of the drivetrain within the first coolant circuit portion.

10. The vehicle of claim 9, further comprising a blower, and wherein the airflow path includes the blower, the heater core downstream of the blower, the heat pump heater downstream of the blower, and the positive temperature coefficient heater downstream of the heat pump heater.

11. The vehicle of claim 1, wherein the vehicle comprises a battery electric vehicle, and the drivetrain includes an electric motor and a high voltage battery.

12. A method of operating a vehicle cabin heating system of battery electric vehicle, the method comprising:
monitoring, by an electronic control unit of the battery electric vehicle, a temperature at a temperature sensor, the temperature sensor being positioned within a vehicle cabin heating system;
based on the temperature being below a threshold temperature, activating a supplemental heater; and
based on the temperature exceeding the threshold temperature, deactivating the supplemental heater and providing vehicle cabin heat via one or both of a vehicle cabin heater core and a heat pump heater.

13. The method of claim 12, further comprising:
based on the temperature exceeding the threshold temperature, adjusting a valve positioned within a coolant system of the vehicle between a first position and a second position, the valve being positioned between a first coolant circuit portion including the drivetrain and a second coolant circuit portion including the vehicle cabin heater core, wherein:
in the first position the valve fluidically connects the first coolant circuit portion to the second coolant circuit portion to flow coolant from a drivetrain to a vehicle cabin heater core and a heat exchanger, and
in the second position the valve recirculates coolant within the first coolant circuit portion without flowing coolant toward the vehicle cabin heater core and heat exchanger.

14. The method of claim 13, wherein the temperature sensor comprises a coolant temperature sensor positioned within the first coolant circuit portion and the supplemental heater comprises a high voltage (HV) coolant heater positioned within the second coolant circuit portion.

15. The method of claim 12, wherein the supplemental heater comprises a positive temperature coefficient heater having a higher energy consumption rate than the heat pump heater, and wherein monitoring the temperature comprises monitoring an air temperature at an output of the heat pump heater.

16. A vehicle cabin heating system comprising:
a vehicle cabin heater core fluidically connected to a coolant system of a vehicle;
a refrigerant circulation system;
a heat exchanger fluidically connected to the coolant system and the refrigerant circulation system to transfer heat from the coolant to refrigerant within the refrigerant circulation system;
a heat pump heater fluidically connected to the heat exchanger via the refrigerant circulation system;
a supplemental heater; and
an electronic control unit configured to perform:
monitoring a temperature of at least one of the coolant or air output from the heat pump heater;
based on the temperature being below a threshold, activating the supplemental heater; and
based on the temperature exceeding the threshold, deactivating the supplemental heater and providing vehicle cabin heat via one or both of the vehicle cabin heater core and the heat pump heater.

17. The vehicle cabin heating system of claim 16, further comprising a temperature sensor positioned in an airflow path at an output of the heat pump heater, and wherein the supplemental heater comprises a positive temperature coefficient heater positioned downstream toward the vehicle cabin within the airflow path from the heat pump heater and temperature sensor.

18. The vehicle cabin heating system of claim 16, further comprising a blower providing airflow within an airflow path toward the vehicle cabin, the airflow path including the vehicle cabin heater core, the heat pump heater, and the supplemental heater.

19. The vehicle cabin heating system of claim 16, wherein the supplemental heater comprises a high voltage (HV) coolant heater positioned within a portion of a coolant system of the vehicle, and configured to heat coolant circulated to the vehicle cabin heater core and the heat pump heater.

20. The vehicle cabin heating system of claim 16, wherein the heat exchanger is fluidically connected downstream from the vehicle cabin heater core within the coolant system.
